(19) United States
(12) Patent Application Publication
(10) Pub. No.: US 2018/0114265 A1
(43) Pub. Date: Apr. 26, 2018

(54) LINE ITEM BASED DATA EXTRAPOLATION AND SIMULATION

(71) Applicant: SAP SE, Walldorf (DE)

(72) Inventor: Georg Dopf, Schwetzingen (DE)

(21) Appl. No.: 15/332,226

(22) Filed: Oct. 24, 2016

(51) Int. Cl. G06Q 40/00; G06Q 10/06; G06F 17/50

(52) U.S. Cl. CPC G06Q 40/00; G06F 17/5009; G06Q 10/067

(57) ABSTRACT

A system, medium, and method for extrapolating financial data based on line items of a transactional system, the method including receiving a request to determine a key indicator for a period having a future end date; obtaining financial data representing at least one of an accurate account of: actual posted data for the period, costs and revenues data, recurring entries, extraordinary postings that occur strictly in the time period, and effects of closing activities due to a closing of the period on the future end date, all of the financial data being based on line item entries in financial data model including an accurate record of financial details for an organization; generating a key indicator for the period; and presenting, in response to the request, a record of the generated key indicator.

Analyzing accounting KPI's (key performance indicators) in advance of a fiscal period end using simple aggregation of actual line items may be a useless or at least not insightful activity since actual data from day to day operations of an organization will continue to be posted until the end of the period and postings triggered by the financial close itself may also influence the accounting KPI's. However, the determination, forecasting, and analysis of key target financial figures and trends for a fiscal quarter, a full fiscal year, or other periods of time may be desired.

### BRIEF DESCRIPTION OF THE DRAWINGS

FIG. 1 is an example graph of a key indicator for a period of time, including the components forming the indicator according an embodiment.

FIG. 2 is an example diagram depicting processing of illustrative costs and revenues from running operations, according to some embodiments.

FIG. 3 is an example embodiment of a flow diagram for a process herein.

FIG. 4 is an example graph of a key indicator and the constituent components thereof over a period of time, according an embodiment.

FIG. 5 is an example comparison graph of a key indicator over different periods of time, according an embodiment.

FIG. 6 is an example apparatus according to some embodiments.

### DETAILED DESCRIPTION

Some embodiments herein are associated with systems and methods for extrapolating key indicators and other characterizations of financial data for transactions systems by one or more of a computer system, apparatus, service, and application. The key indicator may be generated in response to a request for such information. As used herein, a transaction system may refer to one or a combination of a system, apparatus, service, and application performing one or more processes for a big business, company, or organization. The big organization may use a transactional system in order to collect all of the transactions performed by the organization. The transactional system may include an accounting component. It is noted that a traditional accounting system typically only reflects transactions that will have an impact on the balance sheet (BS) or P&L (profit and loss statement) according to generally accepted accounting principles (GAAP). Conventional accounting systems do not reflect transactions that will have effect on BS and P&L in the future. An example of a transactional system may be the computer system(s) of a multinational company with a number of offices located in different countries that are staffed by 1000's of people working to perform different operational transaction tasks or processes, both internal and external to the organization, to fulfill the organization's mission (e.g., sales, education, one or more other services, etc.).

The present disclosure relates to a technical approach to data extrapolation and reporting that is based on financial accounting line item entries of a transactional system. For the composition of a KPI, different types of line items may be used in some embodiments, including actual line items of posted entries for a current posing period, line items from one or more past posting periods (e.g., recurring entries that are repetitive),and new line items (i.e., not yet actual (posted) line items, such as, for example, line items tracked in an extension ledger). Being fundamentally based on line items, all data extrapolations and reports herein may be traced or tracked back to the underlying line items forming the basis of the data extrapolation. In some aspects, the processes herein may be seen as being “audit trail quality” given the traceability of the resultant data extrapolations and reports.

In some example embodiments, a full line item based approach as outlined herein may rely on a superfast in-memory technology platform (e.g. HANA by SAP) in order to process the usual and expected data volumes. Additionally, example embodiments herein may correlate line item entries and the analysis thereof to a “CPU-date/time”. CPU-date/time” based KPI's are not compatible with traditional accounting systems based solely on a posting date/period.

In some aspects, a process herein may rely, at least in part, on some standard financial accounting and reporting tools. In some regards, the particular accounting and/or reporting tool is not itself of critical importance. What is important in some embodiments herein is that the financial data reported by a transactional system accurately reflects the realities of the business or organization associated with the transactional system. That is, the financial data reported and analyzed by the transactional system should be accurate so that the processes disclosed herein may provide results accurately indicative of the business or organization associated with the transactional system currently and at some future point in time.

In some embodiments, a financial data model including an accurate record of the financial details for a transactional system is provided (or otherwise exists) and access to the data of the financial data model is at least made available to the processes and systems herein. In some aspects, the financial data model may include all of the financial data relating to the transactional system, including in some embodiments at least the financial data deemed reportable by an industry or governmental agency or association. In some instances, the data recorded in the financial data model may exceed the standards, requirements, or recommendations of an industry, government, or professional organization related to the transactional system. In one embodiment, a financial data model herein may be provided or based on the Universal Journal by SAP (the assignee hereof). The Universal Journal is a single source document including the all of the relevant entries for a transaction for all categories of financial data related to a transactional system, thereby eliminating a need for data reconciliations. All of the data may be organized in a same format and conform to common constraints and specifications. A data model herein may provide cross component definitions and implementations for multiple parallel currencies, valuations of data, use entities, etc.

An illustrative example will be used throughout the following portion of this disclosure to highlight some features and aspects of some embodiments. It should be appreciated that this example is not meant to be limiting or exhaustive but instead illustrative of one or more of the features introduced herein. The example scenario includes a desire to, on September 15^{th}, anticipate and predict a key financial indicator for the third quarter that ends on September 30, where the key indicator is the earnings before taxes (EBT) for the third quarter. The key indicator could, in some instances, be other metrics or key performance indicators (KPIs).

It is noted that conventionally, the EBT figure could only be provided after the closing of the books of the fiscal quarter for the subject organization, that is sometime in early October (at best).

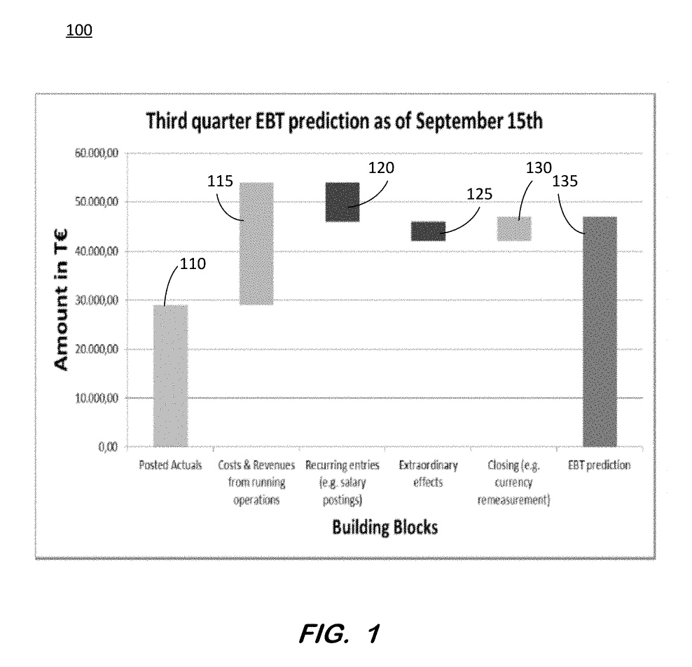

The present disclosure includes a technical solution that is schematically represented, at least in part, by the illustrative depiction in FIG. 1. FIG. 1 includes a graph 100 including plots of the building blocks or contributing components of the EBT key indicator. Graph 100 lists the building blocks of the EBT along axis 102 and the value scale along axis 104. In the present example, the target or goal is to extrapolate the EBT for the third quarter from the financial data (obtained from Universal Journal entries for the transactional system) on September 15th. The predicted/extrapolated EBT is shown in graph 100 at bar 135. The components contributing (plus and minus) to the EBT are represented in FIG. 1 by bar graphs 110, 115, 120, 125, and 130. Bar graph 110 represents that financial data that has actually been posted by September 15^{th}. While not all of the data up until September 30^{th} (the end of the period of interest) has been posted, the data that has been posted is captured and represented by bar graph 110. There will (likely) be additionally financial data that will post between September 15^{th} and September 30^{th}, however that data is not represented by bar graph 110. The “posted actuals” makes no assumptions regarding data not yet posted, it only captures the data that has actually posted. Therefore, bar graph 110 accurately reflects the realities of the transactional system. While bar graph 110 may be accurate through September 15^{th}, it alone is insufficient to represent the EBT at period end.

In some instances, the posted actuals (and other types of data herein) may be recorded and maintained by a database system, including in some instances an in-memory database system that is capable of processing, aggregating, and filtering large amounts of data extremely fast.

Costs and revenues from running (i.e., on-going) operations are represented by bar graph 115 in FIG. 1. These costs and revenues represent items that most likely/probably will be posted up until the end of the period and they are missing from the posted actuals. In some respects, these costs and revenues may primarily be due to deals, contracts, agreements, etc. that will close between the current date and the end of the period (i.e., September 30^{th}). In some instances, the costs and revenues captured by bar graph 115 and their relevancy regarding the EBT 105 may be significant. In the present example, the revenues exceed the costs for the running operations and the net result is a positive contribution from this component towards EBT 105.

In some instances and aspects, upcoming costs and revenues may be indicated, at least in part, by one or more early indicators in a transactional system. For example, different parts of a process chain may indicate or anticipate upcoming costs and revenues. Examples can include purchase requests, opportunities, sales orders, invoice alerts, etc. That is, portions of a process chain may very well indicate approaching costs and/or revenues even though the costs and revenues have not yet been realized. Therefore, some embodiments herein may key on processes to better determine upcoming costs and revenues.

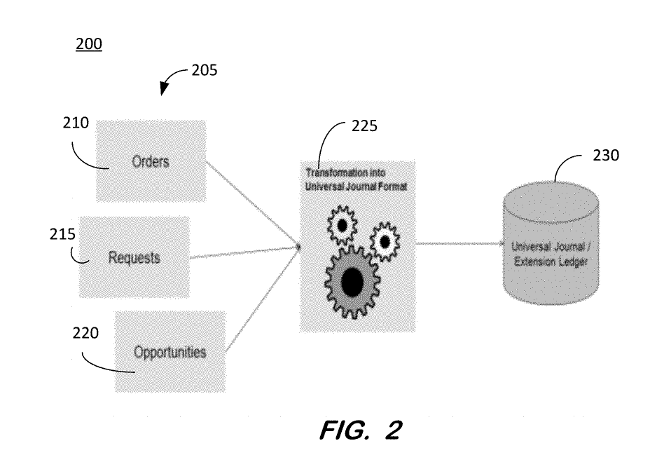

In some embodiments, respective transactional steps or operations may be translated into a format for entry as a line item in a data model (e.g., “Universal Journal”, table ACDOCA). Accordingly, ACDOCA (or other) may be the target format wherein respective entries will technically operate as regular journal entries (e.g., G/L account, balance zero, profit center entities, etc.). Based on this translation, the process chain steps may be recognized and treated as costs or revenue to be realized until the end of the period. FIG. 2 is an illustrative schematic depiction of a translation process to enter process chain events in the Universal Journal (or other data model) as transactional revenue and/or cost entries. In FIG. 2, a number of process chain events are shown at 205, including but not limited to or necessarily including orders 210, requests 215, and opportunities 220. Events 205 are translated or otherwise transformed into representative transactional revenue and/or costs entries and formatted accordingly by a transformation engine or module 225. The transformed and properly formatted data may be entered into the data model (e.g., Universal Journal) and stored in an associated data store 230. It is noted that data from events 205 including, for example, early indicators not yet posted, are transformed into exactly the same (or at least similar) structure as the actuals. In this manner, a holistic reporting solution (with entities like G/L accounts, profit centers etc.) across actual data and “predicted” data may be provided in some embodiments herein (in contrast to a “solution” only reflecting actual commitments). Therefore, some embodiments can correlate actual data (actual world, realization of an opportunity) to early indicators (initial opportunities).

In some aspects, the process chain events represented at 205 in FIG. 2 might not be able to be posted as regular journal entries, at least from a legal (and/or other) perspective. The present disclosure therefore proposes posting the respective entries 205 into an “extension ledger”. The extension ledger may be fully realized and supported by systems and other processes herein. In this manner, reporting tools may be used to account for the various revenue entries, including actual postings and some “non-standard” entries due to existing running activities that will become actual postings in the near future with a certain known probability.

In some aspects, changes to process chain events indicative of future costs and revenues of running operations may be processed as each change occurs by translating and “posting” each change in an extension ledger or by performing translations and extension ledger entries periodically in a batch mode. Either way, the important consideration is that the changes to the process chain events are accurately captured and represented in the data model (e.g., Universal Journal and/or extension ledger). For example, once an event is realized and triggers an “actual” Universal Journal entry it may be necessary to invalidate a previous corresponding extension ledger entry, for example, once a purchase request becomes “real” in terms of accounting wherein it has to be posted as an actual entry. In this manner, the data model accurately reflects the reality of this particular situation. Additionally, this aspect of the present example further illustrates the traceability of extension ledger items (i.e., via the line item entries) to respective, for example, orders, requests, etc.

On September 15^{th}, it is noted that at least some recurring entries may have not yet posted. While they may have not yet posted, they will by the end of the period and should therefore be accounted for in the determination of EBT 105. Examples of recurring entries may include financial items such as, for example, (base) salaries, fixed asset depreciations, recurring invoices, and other matters and are represented by bar graph 120 in FIG. 1. Since these items are recurring (not necessarily every period; for example, every other month, once every quarter, etc.), it is known that they are missing from the posted actuals but will be happening. As such, the present process anticipates these recurring entries and includes their contribution (plus or minus) to the EBT 105. In the present example, the recurring expense of salaries has the effect of reducing the EBT, therefore bar graph 120 in FIG. 1 is colored red to visually indicated its negative impact on EBT 105.

In some aspects, missing periodic postings may be substituted with a posting form a previous period. This approach may be appropriate where the periodic posting has a similar value in different periods of time (e.g., each month or quarter). For example, base salaries and asset depreciations may often fit this criterion by having a similar value over a number of periods. In some regards, the particular activity being reported may determine how similar the values for the periodic postings need be in order for the values to be represented by a substitute value. A user or system may have to recognize the value for a transaction is consistent period to period and appropriate for this type of substitution. In a continuing effort to maintain traceability and accountability in the processes herein, the source of the substitute entry should be tracked and maintained.

Bar graph 125 represents extraordinary effects or postings that occur only during the current period of interest (i.e., not yet posted and not recurring in a predictable manner). For example, one such costs may be due to restructuring of a company. This type of event and the costs associated therewith are not recurring but must be accounted for in the determination of the key indicator (e.g., EBT 105). In the present example, the restructuring costs have a negative impact on the EBT and bar graph 125 is visualized in the color red.

In some embodiments, the classification of events as extraordinary is key to accurately accounting for such events in some of the processes herein. Also, extraordinary events may be entered into an extension ledger since they may rightfully be entered as a regular entry only later in a posting period when they are posted (the preliminary entry in the extension ledger will be wiped out by the actual posting). However, processing of both the regular “base” ledger and the extension ledger(s) herein will yield an accurate view and determination of the target key indicator(s).

In many instances, the closing of a period will itself have an effect on a target key indicator. This may be due to one or more activities associated with closing out of a fiscal quarter. One such activity may be, for example, a currency remeasurement activity that can only be accomplished after the period of interest is closed. For this activity, the exchange rate needed to execute the remeasurement can be known, at the earliest, on September 30^{th} (i.e., the end of the period). However, the determination of EBT on the 15^{th} of September requires some accounting of the remeasurement activity in order to have an accurate determination of the EBT.

In some embodiments, a currency remeasurement can be simulated and “posted’ to an extension ledger in an effort to have some reliable predictive value for the measurement before the actual calculation of the currency measurement. In an instance a simulation is used for this or other similar functions, then the simulated value is replaced by an actual value upon the actual remeasurement. In some embodiments, extension ledger entries resulting from other categories herein (e.g., costs and revenues from running operations) may be included in a remeasurement simulation run. Hereto, the source of line items is tracked and maintained for tracking (and other) purposes.

In some embodiments, activities that may typically be processed in a batch run during a period closing may be processed on a transactional basis. In some instances, as process is performed in a transactional system, a revenue recognition posting can be triggered. As an example, an employee staffed on a project performs a time confirmation, thereby triggering a posting of revenue event. Such “soft close” events can be accounted for as the triggering events occur, thereby eliminating a batch run at the need of the period. Also, in this manner, the actual posting data is enhanced and made richer sooner in a period.

In some instances, closing activities may be predictable since some follow very strict and repetitive patterns each period. As such, the result of past periods may be used to supply values for those closing activities that repeat, until the actual data for a particular closing activity is obtained based on an actual performance of a closing activity.

Referring still to FIG. 1, all of the components contributing (positively and negatively) to the target key indicator (e.g., EBT) are depicted in FIG. 1. The data forming the basis for the contributing factors or building blocks may be obtained from an accurate data model for the transactional system reflected in FIG. 1. In some instances, fewer, more, or alternative building blocks or “ingredients” for the target, key indicator may be included in a graph similar to FIG. 1 for a transactional system, depending on the specifics of the situation where the specifics are specified by the actual data represented in the data model. It is noted that activities that may not impact a particular target indicator may not be factored into the determination of that key indicator. Given the accuracy and completeness of the underlying data model contemplated herein, an analysis of the data model may be performed to ascertain which aspects impact each particular target indicator.

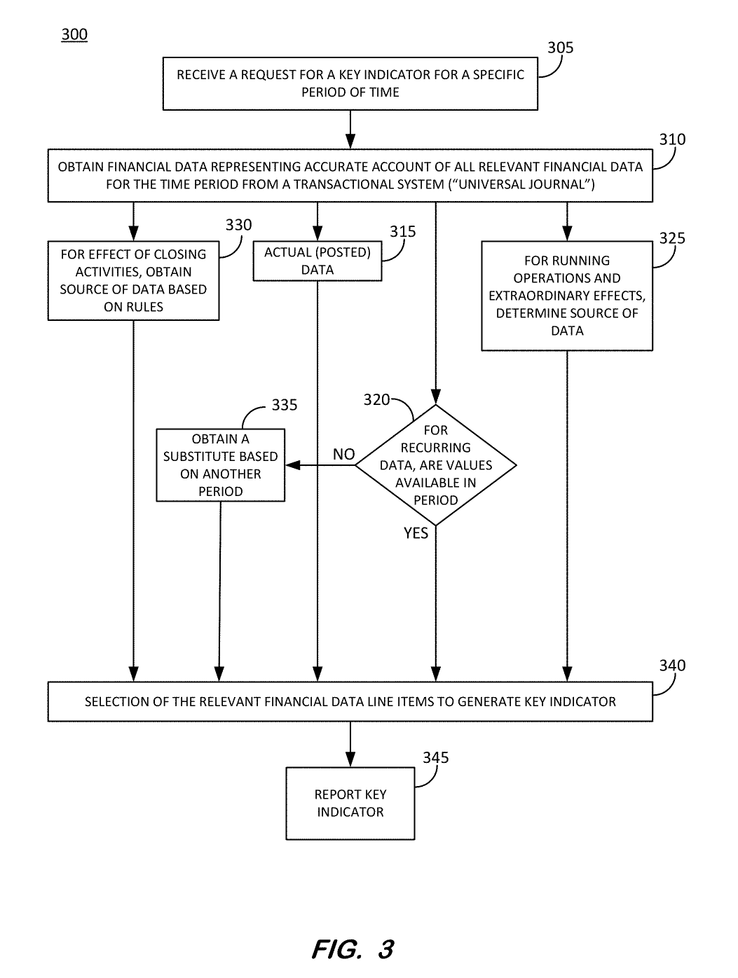

FIG. 3 is an illustrative process 300 according to one embodiment herein. At operation 305, a request for a key or target indicator (e.g., KPI) for a specific period of time is received by a system, device, or service implementing some aspects herein. In response to the request, financial data representing a comprehensive and accurate account of all of the relevant financial data contributing to the key or target indicator for the specified time period by a transactional system is obtained at operation 310. Operation 310 may include determining which data in a “Universal Journal” is relevant to the particular target indicator and/or time period. The composition of the KPI may include a number of different types of data, including for example, actual (i.e., posted) data 315, recurring data 320, running operations data and extraordinary data 325, and closing effects data 330.

For the actual data 315 component of the KPI as indicated in the Universal Journal (or other tool, system, or service), the actual data is selected from the Universal Journal (or other tool, system, or service) for inclusion in the determination of the KPI.

For recurring data 320 (e.g., revenues and/or costs that repeat in different periods), a determination is made regarding whether value(s) for the recurring data is available in the period of interest (e.g., a current period). If the value(s) for the recurring data are available, then process 300 proceeds to operation 340 where the value(s) for the data are selected from the Universal Journal (or other tool, system, or service) for inclusion in the determination of the KPI. If the value(s) for the recurring data are not available in the period of interest, then substitute value(s) can be obtained for the recurring data at operation 335. In some instances, a substitute value may be calculated based on another period including historical data for the recurring value. In some instances, the value(s) for the recurring data may be the same or similar in the other periods including the recurring data. In one example, the value(s) for the recurring data may be determined based on a calculation using historical data from other periods. The substitute value(s) for the recurring data are selected by operation 340 from the Universal Journal or an extension ledger of the Universal Journal (or other tool, system, or service) for inclusion in the determination of the KPI.

Regarding running operations and extraordinary effects data as represented in FIG. 3 at 325, an appropriate source for the data is determined, whether it is a substitute value or an extension ledger entry. After the governing rules and other considerations are processed at 325 to source the relevant data, the running operations and extraordinary effects data can be selected at operation 340 from the Universal Journal or an extension ledger of the Universal Journal (or other tool, system, or service), where an analysis of the financial data is performed to generate the KPI.

For the effects of closing activities data shown at 330, an appropriate source for the data is obtained, whether it is a substitute value determined by a simulation or historical data that is reliable because of the repeating nature of the activity. After the governing rules and other considerations are processed at 330, closing effects data is selected by operation 340 from the Universal Journal or an extension ledger of the Universal Journal (or other tool, system, or service), where an analysis of the financial data is performed to generate the KPI.

From operation 340, a report of the key indicator is provided. In agreement with other aspects herein, aspects of the key indicator reported at 345 can be traced to the line items providing the source of the data contributing to the determination of the key indicator.

In some aspects, a determination of a key indicator herein allows an end user the benefit of the analysis of a period of time (e.g., third quarter EBT) each calendar day. In some embodiments herein, a “CPU” date or date of the transactional system (e.g., a CPU clock of a component system or device comprising the transactional system) is used instead of a “posting” date. This approach is used herein since a fundamental question addressed in some aspects is what key indicator value do we get on a specific date (e.g., September 15^{th}, September 16^{th}, etc.). The specific date on which data was actually visible in the system is critical to this determination. This date is the CPU date. The posting date for the data is not as or very useful for some of the analysis herein, since a data item might be visible to the system on September 15 and yet have a posting date of September 30. For example, data may have a CPU timestamp of September 9^{th}, whereas it will have a “posting” date of September 30^{th}. In order to get an accurate extrapolation of data to determine a target key indicator before the end of the time period, we desire the use of actual known data when it is actually obtained/known (i.e., the CPU date of the data). In this manner and strategy, the methods and systems disclosed herein may provide a mechanism to more efficiently and accurately detect, for example, trends.

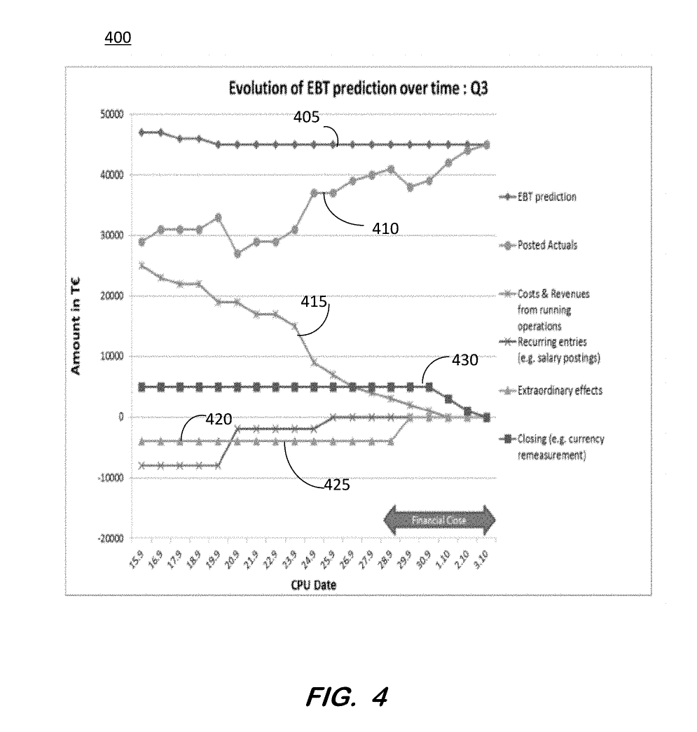

FIG. 4 is an illustrative depiction of a EBT indicator evolving over a period of time, based on data specified by its CPU date. As seen in graph 400 in FIG. 4, the building blocks of the EBT 405 evolve (i.e., change) over the depicted time period as more data actually becomes known. As seen, the amounts for each building block is shown for each day included in the graph. Of note, it is seen that the actual posted data curve 410 moves up towards its final end point as more data is actually posted over the period. Meanwhile, the costs and revenues of running operations moves down over time as those revenues and costs associated with running operations and not yet posted decrease over the time period.

The closing activities of curve 430 occur between September 28 and October 3^{rd}. As such, this is where this curve approaches zero since this data is then included in actual data. Likewise, the extraordinary data represented by curve 425 is stored until September 28th in an extension ledger and is posted as actual values on September 29^{th}, wherein this curve goes to zero.

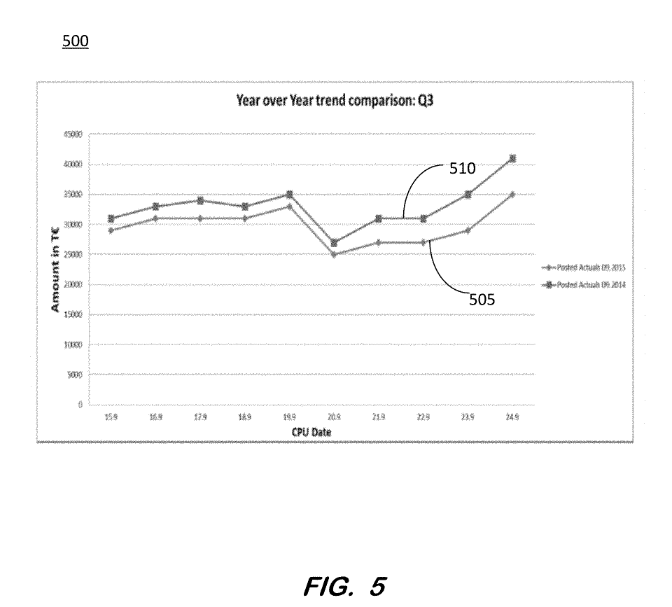

FIG. 5 is an illustrative depiction of a graph showing an example comparison of a KPI trend over a period of time. In this example, values for the posted actuals for the KPI are shown for two different years, 2014 (510) and 2015 (505) as a function of the CPU data for the building blocks. Assuming that the contributions of other building blocks are similar for the two years shown, the trending data shows that since year 2015 data (505) is consistently below year 2014 data (510) and the distance therebetween actually increases slightly, it will be very difficult (i.e., unlikely) to increase EBT of 2015 compared to 2014. It is unlikely, because graph 500 shows what is “already in the box” at a certain point in time (CPU date/time). If for the same business and a period later we have always less “data in the box” in a certain time interval, this gives a strong indication that we will not catch up until the end of the period. It is noted that the graph 500 can be relied on since it is based on CPU dated data.

In the example use-case presented above, a single transactional system key indicator (KPI) was determined. However, the concepts and processes disclosed herein may be extended to cover more than one KPI, to an extend that the underlying data is structured accordingly. In some aspects, the Universal Journal can accommodate this scenario. Accordingly, an appropriate data model can be obtained as well. In some aspects, features of some embodiments may be tuned over time based, in part, on data obtained as the processes herein are implemented. That is, the systems and processed herein can “learn” and improve.

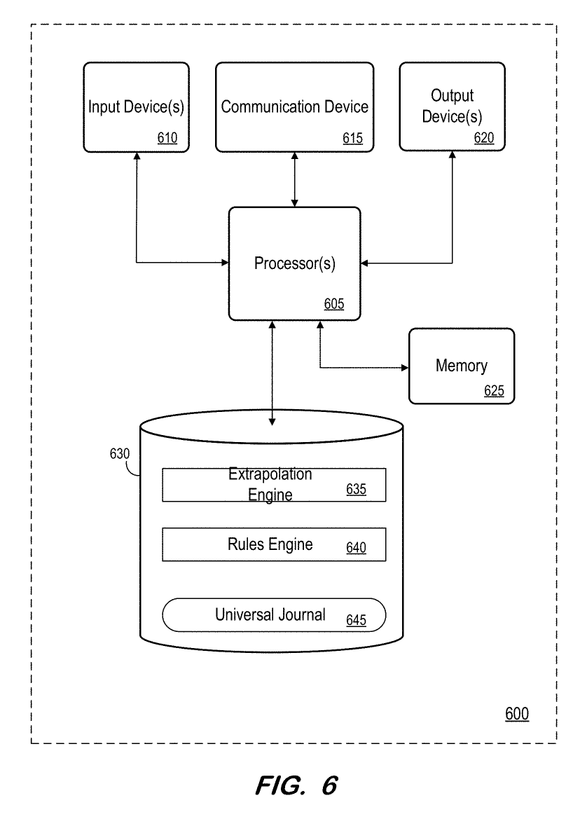

FIG. 6 is a block diagram of apparatus 600 according to some embodiments herein. Apparatus 600 may comprise a general-purpose computing apparatus and may execute program code to perform any of the functions and processes described herein. Apparatus 600 may include other unshown elements according to some embodiments.

Apparatus 600 includes processor 605 operatively coupled to communication device 615, data storage device 630, one or more input devices 620, one or more output devices 625 and memory 610. Communication device 615 may facilitate communication with external devices. Input device(s) 620 may comprise, for example, a keyboard, a keypad, a mouse or other pointing device, a microphone, knob or a switch, an infra-red (IR) port, a docking station, and/or a touch screen. Input device(s) 620 may be used, for example, to enter information into apparatus 600. Output device(s) 625 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Extrapolation engine 635 may be executable by processor 605 to provide any of the functions and processes described herein, including process 300. Embodiments are not limited to execution of these functions by a single apparatus. Rules engine 640 may be consulted in regards to closing effects activities. The data model as supported by the Universal Journal 645 may be stored in storage device 630. Data storage device 630 may also store data and other program code for providing additional functionality and/or which are necessary for operation thereof, such as device drivers, operating system files, etc.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method for extrapolating financial data based on line items of a transactional system implemented by a computing system in response to execution of program code by a processor of the computing system, the method comprising:
receiving, by the processor, a request to determine a key indicator for a period having a future end date;
obtaining financial data representing at least one of an accurate account of: actual posted data for the period, costs and revenues data that will be posted until the future end date, recurring entries that will be posted until the future end date, extraordinary postings that occur strictly in the time period, and effects of closing activities that are due to a closing of the period on the future end date; all of the financial data being based on line item entries in a financial data model including an accurate record of financial details for an organization;
generating, by the processor, a key indicator for the period based on analysis of all of the obtained financial data, the generating of the key indicator including providing an indication of a line item basis for all of the obtained financial data; and
presenting, in response to the request, a record of the generated key indicator.

2. The method of claim 1, wherein the financial data model can produce, for the entries therein, representations for parallel currencies, uniform valuations, and entities for reporting purposes.

3. The method of claim 1, wherein the recurring entries that will be posted until the future end date include contributions due to on-going operations commitments that correspond to some eventual financial posting.

4. The method of claim 3, further comprising:
translating the contributions due to on-going operations commitments into a format for entry into the financial data model; and
entering the formatted translations into the financial data model.

5. The method of claim 4, where the formatted translations are entered into the financial data model with a traceable indication that they include on-going operations commitments.

6. The method of claim 1, further comprising, for the recurring entries that will be posted until the future end date but lacking an entry in the data model, substituting an entry for a particular recurring entry with an actual posting from a previous period for that particular recurring entry.

7. The method of claim 1, further comprising, for at least some of the effects of closing activities that are due to a closing of the period on the future end date, substituting an entry for a particular effects of closing activity entry with an actual posting from a previous period for that particular effects of closing activity entry.

8. The method of claim 1, wherein a timestamp associated with the actual posted data for the period corresponds to a system clock for the transactional system and the key indicator is generated for the period based on a system clock date based analysis of all of the obtained financial data.

9. A system comprising:
a memory storing processor-executable instructions; and
a processor to execute the processor-executable instructions to cause the system to:
receive a request to determine a key indicator for a period having a future end date;
obtain financial data representing at least one of an accurate account of: actual posted data for the period, costs and revenues data that will be posted until the future end date, recurring entries that will be posted until the future end date, extraordinary postings that occur strictly in the time period, and effects of closing activities that are due to a closing of the period on the future end date; all of the financial data being based on line item entries in a financial data model including an accurate record of financial details for an organization;
generate a key indicator for the period based on analysis of all of the obtained financial data, the generating of the key indicator including providing an indication of a line item basis for all of the obtained financial data; and
present, in response to the request, a record of the generated key indicator.

10. The system of claim 9, wherein the financial data model can produce, for the entries therein, representations for parallel currencies, uniform valuations, and entities for reporting purposes.

11. The system of claim 9, wherein the recurring entries that will be posted until the future end date include contributions due to on-going operations commitments that correspond to some eventual financial posting.

12. The system of claim 11, further comprising the processor to execute the processor-executable instructions to cause the system to:
translate the contributions due to on-going operations commitments into a format for entry into the financial data model; and
enter the formatted translations into the financial data model.

13. The system of claim 12, where the formatted translations are entered into the financial data model with a traceable indication that they include on-going operations commitments.

14. The system of claim 9, further comprising the processor to execute the processor-executable instructions to cause the system to, for the recurring entries that will be posted until the future end date but lacking an entry in the data model, a substitute entry for a particular recurring entry with an actual posting from a previous period for that particular recurring entry.

15. The system of claim 9, further comprising the processor to execute the processor-executable instructions to cause the system to, for at least some of the effects of closing activities that are due to a closing of the period on the future end date, a substitute entry for a particular effects of closing activity entry with an actual posting from a previous period for that particular effects of closing activity entry.

16. The system of claim 9, wherein a timestamp associated with the actual posted data for the period corresponds to a system clock for the transactional system and the key indicator is generated for the period based on a system clock date based analysis of all of the obtained financial data.

17. A non-transitory computer readable medium having instructions stored therein, the medium comprising:
instructions to receive a request to determine a key indicator for a period having a future end date;
instructions to obtain financial data representing at least one of an accurate account of: actual posted data for the period, costs and revenues data that will be posted until the future end date, recurring entries that will be posted until the future end date, extraordinary postings that occur strictly in the time period, and effects of closing activities that are due to a closing of the period on the future end date; all of the financial data being based on line item entries in a financial data model including an accurate record of financial details for an organization;
instructions to generate a key indicator for the period based on analysis of all of the obtained financial data, the generating of the key indicator including providing an indication of a line item basis for all of the obtained financial data; and
instructions to present, in response to the request, a record of the generated key indicator.

18. The medium of claim 17, wherein the recurring entries that will be posted until the future end date include contributions due to on-going operations commitments that correspond to some eventual financial posting.

19. The medium of claim 17, further comprising instructions to cause, for the recurring entries that will be posted until the future end date but lacking an entry in the data model, a substitute entry for a particular recurring entry with an actual posting from a previous period for that particular recurring entry.

20. The medium of claim 17, wherein a timestamp associated with the actual posted data for the period corresponds to a system clock for the transactional system and the key indicator is generated for the period based on a system clock date based analysis of all of the obtained financial data.
